(19) United States
(12) Patent Application Publication
(10) Pub. No.: US 2013/0270042 A1
(43) Pub. Date: Oct. 17, 2013

(54) DETERMINING STATES OF ELEVATOR COMPONENTS

(71) Applicant: INVENTIO AG, Hergiswil (CH)

(72) Inventor: Philippe Henneau, Zurich (CH)

(21) Appl. No.: 13/857,597

(22) Filed: Apr. 5, 2013

(30) Foreign Application Priority Data
Apr. 12, 2012 (EP) 12163959.5

(51) Int. Cl. B66B 5/00

(52) U.S. Cl. CPC B66B 5/0006
USPC 187/251

(57) ABSTRACT

A state of at least one support component in an elevator installation can be determined by; determining a characteristic value of the support component, wherein the support component supports a cage and is guided over at least one roller; determining a characteristic value of a reference element, wherein the reference element does not support a cage, wherein the support component and the reference element each comprise at least one tensile carrier and a casing, wherein the at least one tensile carrier is respectively arranged substantially in the casing; determining the state of the support component with consideration of the determined characteristic value of the support component and the determined characteristic value of the reference element.

### CROSS-REFERENCE TO RELATED APPLICATION

This application claims priority to European Patent Application No. 12163959.5, filed Apr. 12, 2012, which is incorporated herein by reference.

### FIELD

The present disclosure relates to elevators.

### BACKGROUND

In elevator installations steel cables have been conventionally used as support means for supporting and/or driving an elevator cage. According to a development of such steel cables, belt-like support means, which comprise tensile carriers and a casing arranged around the tensile carriers, are also used. However, such belt-like support means usually cannot be monitored in customary manner, because the tensile carriers, which determine a breakage load of the support means, are generally not visible through the casing.

In some cases, a test current can be applied to the tensile carriers for the monitoring thereof. A current flow or a current density, a voltage, an electrical resistance or an electrical conductivity is measured in the thus-formed current circuit or in several thus-formed current circuits. A conclusion with respect to a state of being intact or a degree of wear of the support means can be made on the basis of a measured magnitude of that kind. If, for example, the diameter of the tensile carrier reduces due to breakage of individual wires, the electrical resistance of this tensile carrier increases.

### SUMMARY

At least some embodiments of the disclosed technologies provide a method of determining a state of a support means which takes into consideration different environmental influences on the electrical conductivity of the tensile carriers and which is economic and robust, not only in manufacture, but also in use. In addition, further embodiments include an elevator installation with a monitoring device for monitoring a support means, wherein different environmental influences on the electrical conductivity of the tensile carriers of the support means are taken into consideration in determination of a support means state.

In particular embodiments, a method of determining a state of at least one support means in an elevator installation comprises the following steps: determining a characteristic value of the support means, wherein the support means supports a cage and is guided over at least one roller; determining a characteristic value of a reference element, wherein the reference element does not support a cage; the support means and the reference element each comprise at least one tensile carrier and casing, wherein the at least one tensile carrier is respectively arranged substantially in the casing; and determining the state of the support means with consideration of the determined characteristic value of the support means and the determined characteristic value of the reference element.

The use of such a reference element can mean that an additional element is needed for the support means monitoring. The reference element does not support a cage and thereby does not fulfill the normal function of a support means. However, the reference element allows detection of environmental influences such as temperature, air humidity or magnetic fields and thereby a determined characteristic value of the support means can be better assessed. Through the determination of such environmental influences with the help of the reference element the state of the support means can be better determined independently of environmental influences.

In further embodiments, determination of the state of the support means is carried out on the basis of a difference between the determined characteristic value of the support means and the determined characteristic value of the reference element. Through formation of such a difference it is possible to computationally distinguish the environmental influences which act equally on the reference element and on the support means from the influences which the state of the support means has on the characteristic value of the support means.

In additional embodiments a residual breakage force of the support means is determined on the basis of the difference between the determined characteristic value of the support means and the determined characteristic value of the reference element. This can mean that it can be assessed by way of a specific residual breakage force when a support means has to be exchanged in order to guarantee safety of the elevator installation. In particular embodiments the determined residual breakage force is compared with a predetermined threshold value, wherein the elevator installation is blocked for conveying operation if the determined residual breakage force is less than the predetermined threshold value. Depending on the respective safety requirements and design of the elevator installation such a threshold value can be defined at, for example, 60% of the residual breakage force or 80% of the residual breakage force.

In some embodiments the cage is brought into a measuring position for determination of the characteristic value of the support means. This can mean that the characteristic value of the support means is carried out with an unchanged arrangement of the support means in the elevator installation. As a result, successively measured characteristic values of the support means are better comparable with one another. For example, such a measuring position can be defined so that the cage is located at the uppermost story. In an exemplifying form of embodiment the measuring position corresponds with a rest position of the elevator installation, i.e. a position which the elevator installation adopts when no destination calls take place.

In further embodiments the reference element is so arranged in the elevator installation that the reference element is exposed to substantially the same environmental influences as the support means. A largest possible consideration of environmental influences on the support means or the reference element is thereby ensured.

In some embodiments the reference element is guided over the roller and in that case arranged substantially near the support means. The support means and the reference element thereby experience substantially the same change in position during travel of the cage. Such an arrangement can mean that the reference element is arranged very near the support means and thereby experiences almost identical environmental influences. However, it can also mean that the reference element is similarly bent by way of the roller and can thereby experience wear phenomena. Since, by contrast to the support means, the reference element is not under load such wear due to bending by way of a roller can be accepted in certain circumstances.

In further embodiments the reference element is so arranged in the elevator installation that the reference element during travel of the cage does not experience any change in position and that the reference element has substantially the same position as the support means with respect to a height of the elevator installation when the cage is in a measuring position. Such an arrangement of the reference element in the elevator installation can mean that the reference element is not exposed to any loads such as, for example, reverse bending by way of a roller. It can also mean that the reference element cannot be arranged directly near the support means and thereby is not exposed to exactly the same environmental influences as the support means. Through arrangement of the reference element at substantially the same height of the support means in a measuring position it is possible for the greatest part to compensate for this. Depending on the respective elevator installation and prevailing environmental influences it can also be sufficient to arrange the reference element in a different position in relation to the support means. However, the state of the support means can be determined more accurately the more similar the position of the reference element is to the position of the support means.

In further embodiments the cage is arranged in the measuring position for a specific period of time before the characteristic value of the support means is determined. It is thereby achieved that the environmental influences can act on the support means before the characteristic value of the support means is determined. If, for example, it is cool at the bottom in an elevator shaft and hot at the top in an elevator shaft and the cage is arranged in its measuring position at the uppermost story then a specific time period lasts until the support means has adopted the respective ambient temperature. Such a specific time period can, for example, be between 10 seconds and 1 hour, possibly between 1 minute and 30 minutes, possibly between 2 minutes and 10 minutes.

In further embodiments the characteristic value of the support means is an electrical resistance of the at least one tensile carrier of the support means and the characteristic value of the reference element is an electrical resistance of the at least one tensile carrier of the reference element. The use of the electrical resistance as characteristic magnitudes of the state of the tensile carrier and the support means can mean that the application and measurement of electrical current to and at the tensile carrier is economic and robust. In alternative embodiments an acoustic signal is coupled into the tensile carriers or ultrasonic waves are coupled into the tensile carriers instead of an electric current. The determination of a state of a support means with the help of a reference element can, in principle, take place with any form of characterization of the support means.

In order to take into consideration the influence of a loading of the cage one or more learning journeys are, in some embodiments, carried out. Thus, for example, a learning journey is carried with a full cage and a learning journey with an empty cage can be carried out. In certain circumstances, different characteristic values of the support means thereby result. This can mean that determination of the characteristic value of the support means can take place not only in the case of an empty cage, but also in the case of a full cage without the different loading of the support means in that case falsifying a statement about the state of the support means.

In further embodiments minimum and/or maximum values are defined for the reference element. Determination of the state of the support means can then take place only when the determined characteristic value of the reference element lies within this predetermined range. As a result, it is possible to prevent damage of the reference element being recognized and there is thus prevention of false determination of the state of the support means. It could, for example, happen that the reference element is rusty or separated. Such damage of the reference element would no longer permit accurate determination of the state of the support means. Through an adapted definition of a minimum and/or maximum characteristic value of the reference element such erroneous determinations can be avoided.

In additional embodiments, an elevator installation comprises a cage, a support means, wherein the support means supports the cage and is guided by way of at least one roller, a reference element, wherein the reference element does not support a cage, and a monitoring device, wherein the support means and the reference element each comprise at least one tensile carrier and casing, and wherein the at least one tensile carrier is respectively arranged substantially in the casing and wherein the monitoring device is so coupled with the support means and the reference element that a state of the support means is determinable with consideration of a characteristic value of the support means and a characteristic value of the reference element.

In further embodiments the characteristic value of the support means and the characteristic value of the reference element are each an electrical resistance of the tensile carrier. In that case, the tensile carriers are each electrically contacted by a first contact element and a second contact element. The contact elements contact the support means at a respective end of the support means, wherein these ends of the support means are each relieved of load by a respective support means fastening.

In further embodiments the tensile carrier of the support means and the tensile carrier of the reference elements consist of the same material and have substantially the same cross-section. This can mean that the characteristic value of the support means is directly comparable with the characteristic value of the reference element.

In further embodiments the reference element has fewer tensile carriers than the support means. This can mean that the reference element can be more favorably constructed. Since the reference element does not fulfill a supporting function, under certain circumstances it is not necessary to arrange as many tensile carriers in the reference element as in the support means.

The determination, which is disclosed here, of a state of a support means can be used in different forms of elevator installations. Thus, for example, elevator installations with or without a shaft or with or without a counterweight or elevator installations with different translation ratios are used. Thus, every support means which supports a cage in an elevator installation can be monitored by the methods or device disclosed here.

A roller in the sense of this disclosure is a drive roller or a deflecting roller or a support roller.

### BRIEF DESCRIPTION OF THE DRAWINGS

The disclosure refers to the following figures, in which:

FIG. 1 shows a schematic illustration of an exemplifying elevator installation,

FIG. 2 shows a schematic illustration of an exemplifying elevator installation,

FIG. 3 shows a schematic illustration of an exemplifying elevator installation,

FIGS. 4a-4e show an exemplary embodiment of a reference element,

FIG. 5 shows an exemplary embodiment of a monitoring device and a reference element and a plurality of support means,

FIG. 6 shows an exemplary embodiment of a support means fastening and a contact element and

FIG. 7 shows an exemplary embodiment of a method for determining a state of a support means.

### DETAILED DESCRIPTION

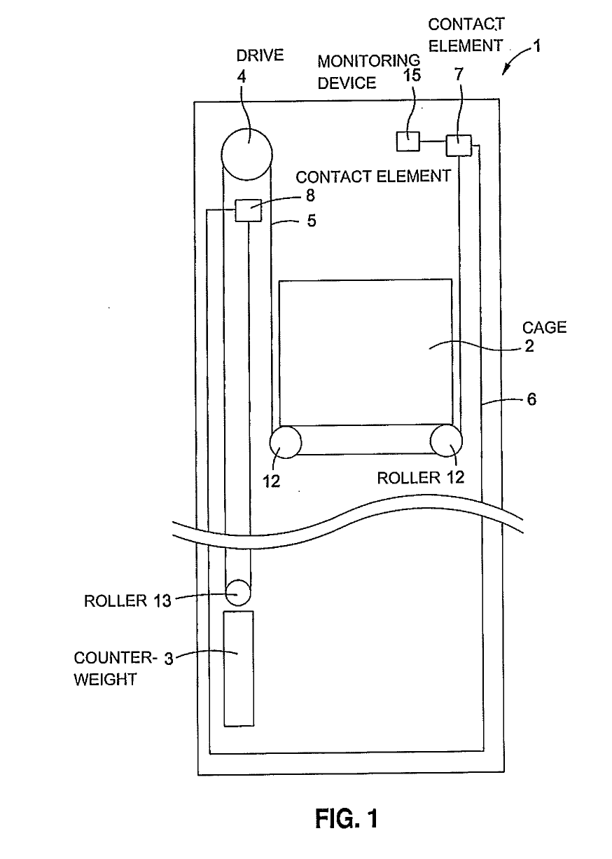

An exemplary embodiment of an elevator installation 1 is illustrated in FIG. 1. The elevator installation 1 comprises a cage 2, a counterweight 3, a drive 4 and a support means 5. In that case, the support means 5 is fixed in the elevator installation by way of a first support means fastening (not illustrated), guided over a counterweight roller 13, guided over the drive 4, guided over two cage support rollers 12 and fastened again in the elevator installation by a second support means fastening (not illustrated). A respective first contact element 7 and a respective second contact element 8 are arranged in the region of the support means fastenings (not illustrated). The tensile carriers of the support means 5 are acted on by an electric current with the help of these contact elements 7, 8.

A reference element 6 is similarly arranged in the elevator installation 1. The reference element 6 is in that case arranged substantially around a travel path of a cage 2 and of the counterweight 3. The reference element 6 is, like the support means 5, contacted by the first contact element 7 and by the second contact element 8. The tensile carriers of the reference element 6 can thus also be acted on by an electric current.

The first contact element 7 is coupled with a monitoring device 15. The characteristic values, which are determined by the first contact element 7, of the support means 5 and of the reference element 6 are evaluated by the monitoring device 15 in order to determine the state of the support means 5.

The exemplifying elevator installation 1 in FIG. 1 comprises a counterweight 3. In an alternative form of embodiment (not illustrated) the elevator installation does not include a counterweight. In such an elevator installation without a counterweight use can similarly be made of a reference element in order to determine the state of the support means.

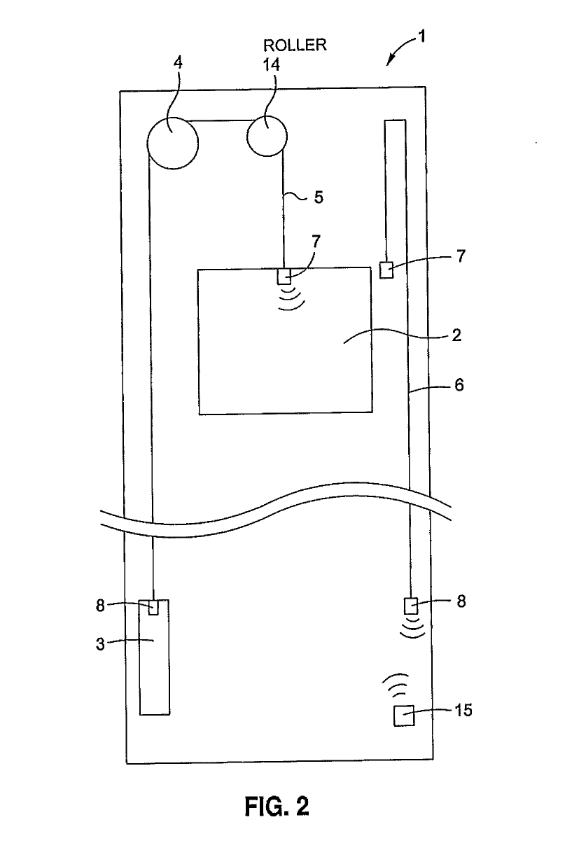

A further exemplifying form of embodiment of an elevator installation 1 is illustrated in FIG. 2. By contrast to the elevator installation in FIG. 1 the cage 2 and the counterweight 3 in this embodiment are suspended directly. The support means 5 is in that case fastened to the cage 2 and to the counterweight 3. The support means 5 is additionally guided over a drive 4 and a deflecting roller 14. The first contact element 7 and the second contact element 8 are respectively again arranged at the ends of the support means 5.

The reference element 6 is similarly arranged in the elevator installation 1. The reference element 6 is also contacted at its ends by a first contact element 7 and a second contact element 8. The reference element 6 is so arranged in the elevator installation 1 that it has substantially the same position as the support means 5 with respect to a height of the elevator installation 1 when the cage 2 is in the illustrated position.

The elevator installation 1 additionally comprises a monitoring device 15. In this embodiment the contact elements 7, 8 and the monitoring device 15 are coupled together without wires.

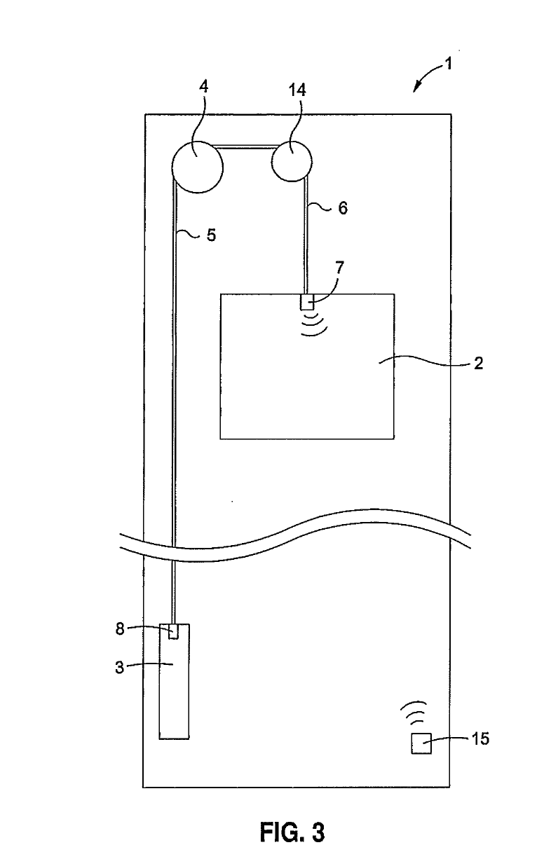

A further exemplary embodiment of the elevator installation 1 is illustrated in FIG. 3. By contrast to the elevator installation in FIG. 2 the reference element 6 in this embodiment is so arranged that the support means 5 and the reference element 6 during travel of the cage 2 experience substantially the same change in position. The reference element 6 is in that case guided, like the support means 5, over the drive 4 and the deflecting roller 14. By contrast to the support means 5, the reference element 6 does not, however, support the cage 2, but runs only near the support means 5. The reference element 6 is less strongly tensioned than the support means 5.

Not only the support means 5, but also the reference element 6 are contacted at the ends thereof by a first contact element 7 and by a second contact element 8. The contact elements 7, 8 are again coupled with the monitoring device 15 without wires.

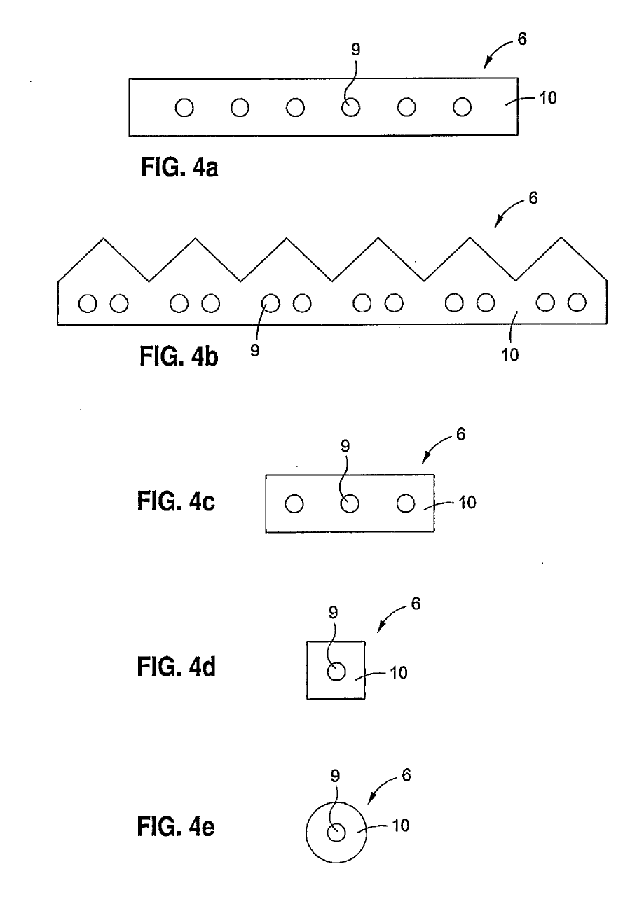

Exemplary embodiments of a reference element 6 are illustrated in FIGS. 4a to 4e. The reference element 6 comprises at least one tensile carrier 9 and a casing 10. In that case, the at least one tensile carrier 9 is arranged in the casing 10. The number of tensile carriers 9 as well as the shape of the casing 10 can be differently designed. In that case, the reference element 6 can have the same form as the support means (not illustrated) or, however, the reference element 6 can differ in form from the support means.

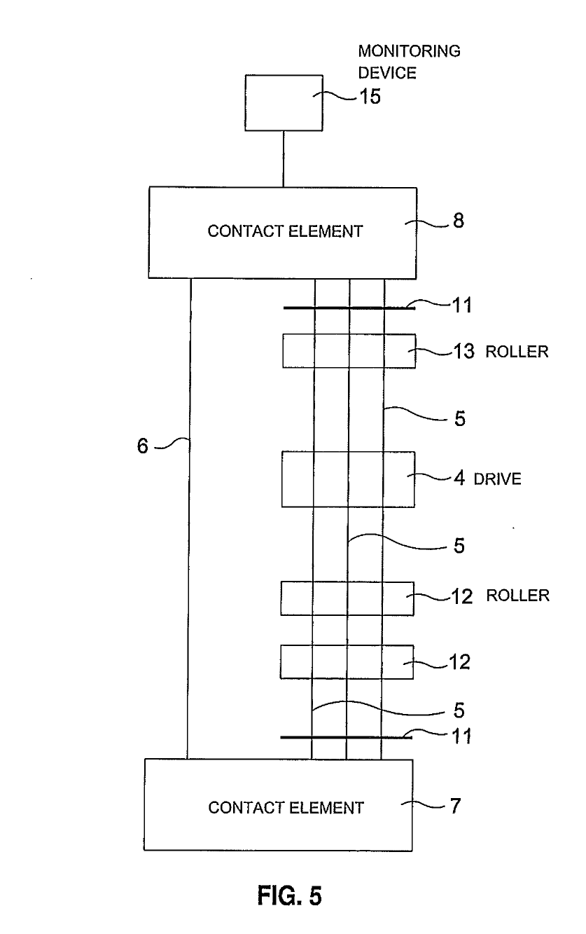

A monitoring device 15, a first contact element 7, a second contact element 8, a reference element 6 and three support means 5 are illustrated in FIG. 5. The reference element 6 as well as the three support means 5 are respectively contacted at the ends thereof by a contact element 7, 8. The three support means 5 are fastened to a first support means fastening 11, then guided over a counterweight roller 13, over a drive 4 and over two cage rollers 12 and again fastened at a second support means fastening 11. These components act on the support means 5, but not on the reference element 6. Since the reference element 6 and the support means 5 are affected by substantially the same environmental influences it is possible, through comparison of the characteristic values of the reference element 6 and the support means 5, to ascertain a change in the state of the support means 5 which arises through the action of a tension loading and a crushing of the support means 5 by the fastening to the support means fastenings 11 and the weights of the cage 2 and the counterweight 3 as well as a bending over the counterweight support roller 13, the cage support roller 12 and the drive 4.

The monitoring device 15 compares each of the three support means 5 with the reference element 6. In an exemplary embodiment the monitoring device 15 also compares the support means 5 with one another. Through such comparisons the state of each individual support means 5, caused by the loading of the support means 5 through load and bending, can be determined.

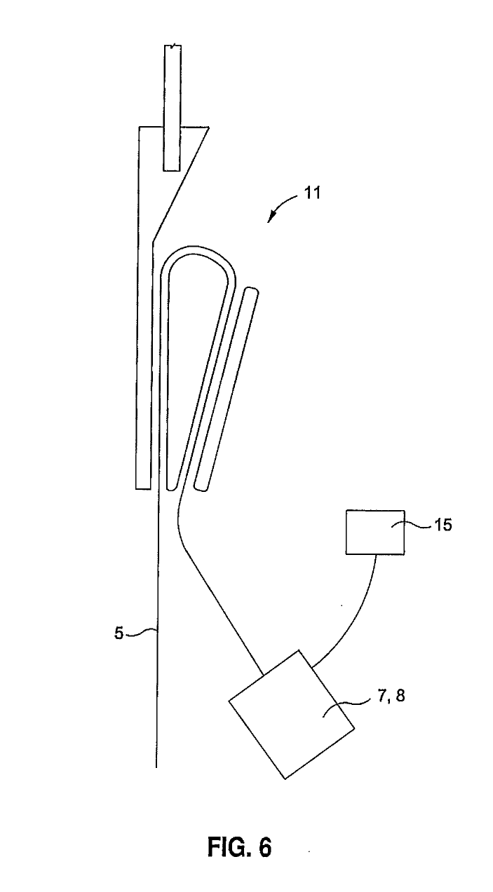

An exemplary embodiment of a support means fastening 11 and a contact element 7, 8 is illustrated in FIG. 6. In this embodiment the support means fastening 11 is designed as a wedge lock. The support means 5 is in that case looped around a wedge, which can be firmly drawn into a housing of the support means fastening 11. The contact element 7, 8 contacts the support means 5 at the unloaded end thereof. The monitoring device 15 is coupled with the contact element 7, 8. Through such an arrangement the support means 5 can be monitored over the entire length thereof including inter alia that section of the support means 5 disposed in the support means fastening 11.

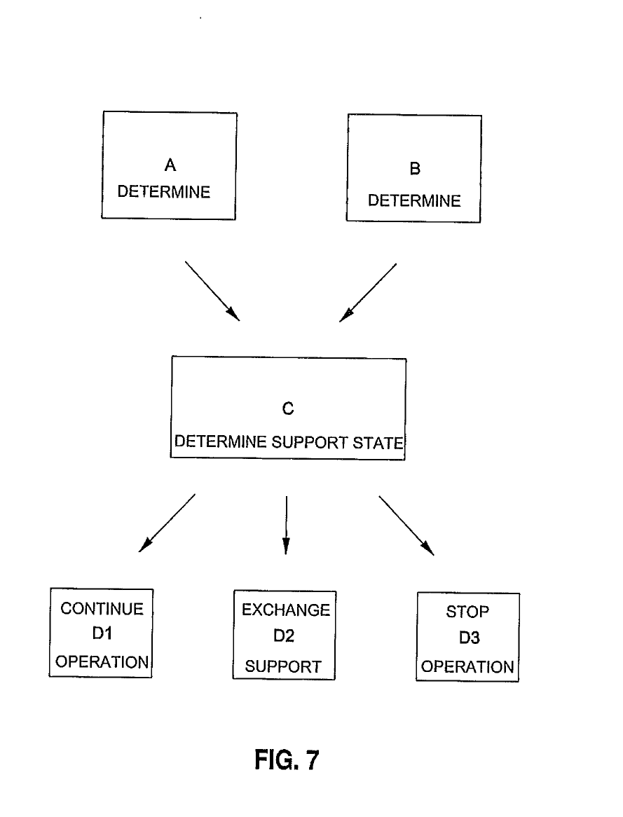

An exemplary embodiment of a method for determining a state of a support means in an elevator installation is illustrated in FIG. 7. Method step A symbolizes determination of a characteristic value of the support means, wherein the support means supports a cage and is guided over at least one roller. Method step B symbolizes determination of a characteristic value of a reference element, wherein the reference element does not support a cage. Method step C symbolizes determination of the state of the support means with consideration of the determined characteristic value of the support means and of the determined characteristic value of the reference element. Depending on the respective determined state of the support means a further method step D1, D2 or D3 follows. If the state of the support means fully satisfies all requirements, operation of the elevator installation is continued without further measures, symbolized by method step D1. If the determined state of the support means partly fulfills the set requirements, operation of the elevator installation is continued and at the same time a signal is transmitted to an operator of the elevator installation, which signal indicates that the support means has to be exchanged within a certain time period. This method step is symbolized by D2. If the determined state of the support means does not satisfy the set requirements, the elevator installation is urgently brought into a safety position and is no longer available for further conveying operations until the support means is exchanged. This method step is symbolized by D3.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator installation method, comprising:
determining a characteristic value of a support component, the support component supporting a cage and being guided over a roller, the support component comprising a first tensile carrier and a first casing, the first tensile carrier being arranged substantially in the first casing;
determining a characteristic value of a reference element, the reference element not supporting the cage, the reference element comprising a second tensile carrier and a second casing, the second tensile carrier being arranged substantially in the second casing; and
determining a state of the support component based on the determined characteristic value of the support component and based on the determined characteristic value of the reference element.

2. The method of claim 1, the determining the state of the support component comprising determining a difference between the determined characteristic value of the support means and the determined characteristic value of the reference element.

3. The method of claim 2, the determining the state of the support component further comprising determining a residual breakage force of the support component based on the determined difference.

4. The method of claim 3, further comprising:
determining that the determined residual breakage force is less than a predefined threshold; and
blocking the elevator installation for a conveying operation.

5. The method of claim 1, the characteristic value of the support component comprising an electrical resistance of the first tensile carrier, and the characteristic value of the reference element comprising an electrical resistance of the second tensile carrier.

6. The method of claim 1, further comprising bringing the cage to a measurement position for the determining the state of the support component.

7. The method of claim 6, further comprising holding the cage at the measurement position for a period of time before determining the characteristic value of the support component.

8. The method of claim 1, the reference element and the support component being exposed to a common group of environmental influences.

9. The method of claim 8, the reference element being guided over the roller and arranged near the support component, the support component and the reference element experiencing about the same change in position during travel of the cage.

10. The method of claim 8, the reference element being immobile during travel of the cage, the reference element having substantially the same height as the support component with respect to a height in the elevator installation when the cage is in a measuring position.

11. The method of claim 1, the support component and the reference element being coupled to a monitoring device.

12. An elevator installation, comprising:
a cage;
a support component, the support component supporting the cage and being guided over a roller, the support component comprising a first tensile carrier and a first casing, the first tensile carrier being arranged substantially in the first casing;
a reference element, the reference element not supporting the cage, the reference element comprising a second tensile carrier and a second casing, the second tensile carrier being arranged substantially in the second casing; and
a monitoring device, the monitoring device being coupled with the support component and with the reference element, the monitoring device being configured to determine a state of the support component based on a characteristic value of the support component and based on a characteristic value of the reference element.

13. The elevator installation of claim 12, further comprising:
a first contact element electrically connected to the first tensile carrier and the second tensile carrier, the first contact element contacting the support component at a first end of the support component;
a second contact element electrically connected to the first tensile carrier and the second tensile carrier, the second contact element contacting the support component at a second end of the support component;
a first fastening component coupled to the support component near the first end of the support component; and
a second fastening component coupled to the support component near the second end of the support component, the characteristic value of the support component comprising an electrical resistance of the first tensile carrier, and the characteristic value of the reference element comprising an electrical resistance of the second tensile carrier.

14. The elevator installation of claim 12, the first and second tensile carriers comprising a same material and having a same cross-section.

15. The elevator installation of claim 12, the support component further comprising an additional tensile carrier, the support component comprising more tensile carriers than the reference element.
